(19) United States
(12) Patent Application Publication
(10) Pub. No.: US 2022/0250999 A1
(43) Pub. Date: Aug. 11, 2022

(54) METHOD FOR PRODUCING A FIBROUS MATERIAL FOR FUNGI, WITH USE IN AGRICULTURE, ECOLOGICAL RESTORATION AND INDUSTRIAL APPLICATIONS

(71) Applicant: INSTITUTO TECNOLOGICO DE SANTO DOMINGO, Santo Domingo (DO)

(72) Inventors: Melvin Santiago Arias Polanco, Santo Domingo (DO); Jose Miguel CAMPANA MUNOZ, Santo Domingo (DO)

(73) Assignee: INSTITUTO TECNOLOGICO DE SANTO DOMINGO, Santo Domingo (DO)

(21) Appl. No.: 17/621,726

(22) PCT Filed: Dec. 12, 2019
(86) PCT No.: PCT/DO2019/050011

§ 371 Date: Dec. 22, 2021

(30) Foreign Application Priority Data
Sep. 26, 2019 (DO) P2019-0246

(51) Int. Cl. C05F 11/08

(52) U.S. Cl. CPC C05F 11/08

(57) ABSTRACT

A method that allows storage, transport and delivery of fungal propagules in a polymer matrix corresponding to microfibers or nanofibers that carry totally or partially encapsulated propagules infectious between fibrous sheets or adhered on their surface with applications in different inoculation strategies in the field of agriculture, horticulture, forestry, ecological remediation, and related areas.

### CROSS REFERENCE TO RELATED APPLICATION

This application is a national stage entry of PCT/D02019/050011 filed Dec. 12, 2019, under the International Convention and claiming priority over Dominican Republic Patent Application No. P2019-0246 filed Sep. 26, 2019.

### HELD OF INVENTION

The present invention refers to a method that allows storage, transport and delivery of fungal propagules in a polymer matrix corresponding to microfibers or nanofibers that carry totally or partially encapsulated propagules infectious between fibrous sheets or adhered on their surface.

### BACKGROUND OF THE INVENTION

Fertilizers are one of the most important requirements for soil fertility maintenance. However, typically nutrients applied in their different chemical forms are not fully accessible to plants because they are deposited in their poorly soluble forms, which causes serious agroecological problems. With the objective of developing profitable and environmentally friendly supplies, biofertilizers have gained significant interest as a partial or total substitute of chemical fertilizers. These biofertilizers known as inoculums microbials are formulations that contain one or more microorganisms that once applied to the leaves, soil, roots or seeds colonize the rhizosphere or the interior of the plants promoting plant development.

Fungi are a type of organisms widely used as a biological recourse, in search of natural solutions for plant nutrition, strengthening of crops, biological control of phytopathogens and other forms of soil improvement and vegetative state. However, its effectiveness may be limited by unavailability of suitable carriers that allow maintaining cell viability in the presence of unfavorable biotic and abiotic factors that may cause a decrease significant in microbiological populations once applied to the soil.

Conventional formulations of fungal inoculants of agricultural interest are presented in delivery system include liquid solutions, inert materials such as sand, clay, coal, vermiculite, perlite, hydrogel beads, compressed powders, granules or organic pills and materials such as peat and compost. However, the application of many of these formulations are economically prohibitive on a large-scale because it would require the non-directed propagation of the inoculum to large areas which represents a high cost per plant.

In previous inventions, methods that allow the delivery of active ingredients in fibrous polymer networks (United States, Patent No. WO2014182799A1, 2016; United States, Patent No. WO2017040655A1, 2017), However, these inventions are aim at incorporating active substances more no to microbiological cellular agents. On the other hand, the immobilization of bodies cell in fibrous polymer matrices has been carried out by methods that involve the encapsulation of cell units in cross-linkable polymers (States United, Patent No. U.S. Pat. No. 8,367,109B2, 2013) and in cell entrapment in nuclei of polymeric matrices (United States, Patent No. WO2012/064287AI, 2012), in both cases the methods may be limited when trying to encapsulate cell units of large dimensions such as fungal spores with sizes 40-150 μm. In other inventions, microbiological structures have been incorporated by the adhesion of the biological material in nanofibers with agricultural and industrial applications (India, Patent No. WO 2017/006345A2, 2017).

The above-mentioned inventions start from uniform mixtures between the polymeric material and the biological ingredient for the production of the biohybridized material, a fact that puts the dormant status of certain biological systems at risk and consequently the cell viability of the biological systems of interest as is the case of spores of arbuscular mycorrhizal fungi. However, these inventions start from uniform mixtures between the polymeric material and the biological ingredient for the production of the biohybridized material, a fact that puts the dormant status of certain biological systems at risk and consequently the cell viability of the biological systems as is the case of spores of arbuscular mycorrhizal fungi. Therefore, there is a need for a method that allows the development of a delivery system of low density, low volume and large surface area for incorporation of fungal units of agricultural, ecological and industrial interest without conflict with the dimensions of the biological structures that are intended to be incorporated, allowing preserve cell viability and controlled release of fungal inoculants with different application strategies so that you can get the most out of its functional characteristics associated with growth, protection and development vegetative.

### BRIEF DESCRIPTION OF THE DRAWINGS

FIG. 1. Mycorrhized seed root coated with inoculant incorporated in PEO fibers. Multiple vesicles (V) and internal hyphae (H) are observed;

FIG. 2. SEM image of polyethylene oxide (PEO) fibers without the mycorrhizal inoculant; and

FIG. 3. Image of the SEM with the inoculant attached to the fiber.

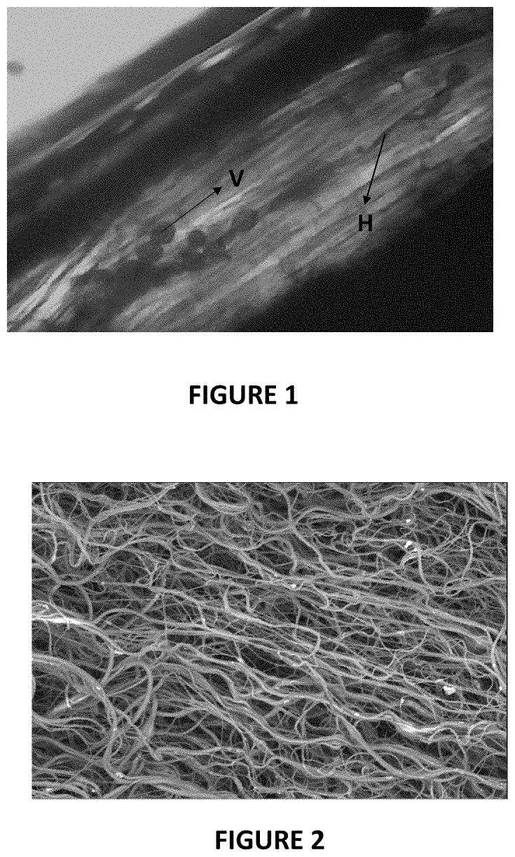

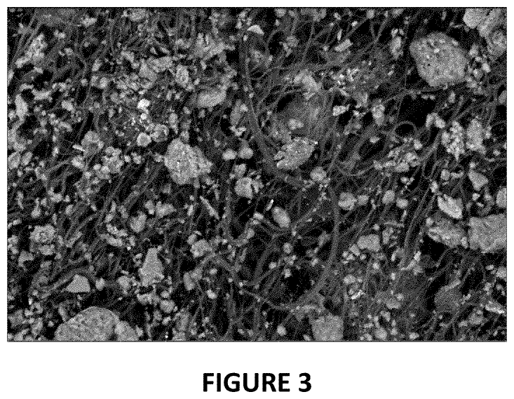

### DETAILED DESCRIPTION

The terminology presented in this document aims to describe particular exemplifications and not intended to be limiting of the presented invention. The term “or” is used to indicate the in which two or more can be carried out. The word “as” and the conjugate forms of the verb “may” and “can” are used in this document to refer to how the elements of the invention and the way in which embodiments can be carried out individuals in an exemplary manner without restricting their scope at all. The adjective “biodegradable” in this embodiment refers to materials that have the capacity of decomposing, safely and relatively quickly by biological means in raw materials of nature and disappear in the environment. The adjective “biocompatible” refers to a material that does not cause any undesirable effects local or systemic on a biological body or biological medium on which it is used, in this case fungi, plants and humans.

The present invention consists on a method for producing a fibrous polymer matrix as a delivery system for fungal propagules, that is, mycotic structures independent capable of spreading. The fungal propagules in this document correspond to fungi of agricultural interest, as they may be species of the genus Trichoderma and mycorrhizae group.

From this embodiment, the delivery system is characterized by being constituted by nanofibers or microfibers made with biodegradable and biocompatible polymers, which can be synthetic or natural, such as cellulose, chitosan, alginate calcium, chitin, collagen, polyvinyl alcohol (PVA), polyethylene oxide (PEO), carboxymethyl cellulose (CMC) and polyvinylpyrrolidone (PVP). The realization includes uniform polymer solutions consisting of independent polymers or mixture of several polymers dissolved in water, in some organic solvent or solvent mixture. The manufacture of the fibrous material consisting of nanofibers or microfibers can be made by techniques such as electro-spinning, self-assembly, phase-induced thermal separation, polymerization, sonochemical synthesis, template synthesis, plasma induction, spinning centrifuge and electrohydrodynamic writing.

The invention also refers to a method which incorporates propagules of fungi that may have been treated with some technique such as desiccation, freezing or lyophilization and presented in the form of gels, compressed powders, pills or capsules and where the incorporation of the fungal units can be carried out with the total or partial encapsulation of the same between fibrous sheets or on the surface thereof during the synthesis of the fibers in the direction of the dispensing flow, perpendicular or angular to this. In the same way, reference is made to a delivery system that allows maintaining viable propagules until release to be applied with different strategies of inoculation during sowing, transplantation or in the treatment of seeds in different fields of agriculture, forestry, horticulture and ecological restoration.

### Example

The parameters presented in these examples are not restrictive and can be variable. Reference is made to illustrate an embodiment with the proposed invention.

Practical Realization 1. Preparation of Polymer Solution.

Solutions of polyvinyl alcohol (PVA), (Mw 85, 000-124; 000; 99+% hydrolyzed) 5%-10%, polyethylene oxide (PEO) (Mw 200,000), 3%-10% and polyvinylpyrrolidone (PVP), (Mw 1, 300,000) at 15%-20% were prepared. The polymers were dissolved in distilled water in a thermostatic bath with stirring at 85° C. for 1 hour to obtain a uniform solution. The resulting solutions are autoclaved at 121° C. and 15 lb of pressure for 15 minutes and then stored at 4° C. until use.

Practical Realization 2. Preparation of Polymeric Fibers and Incorporation of Mycorrhizal Inoculant.

The manufacturing process of the fibrous material was carried out using the spin spinning technique. The polymer solutions previously prepared were deposited in the spinning core gradually and the fibers were produced using hypodermic needles of 27G×½″ until a dense amount of fibers was generated in the vertical busbars. The parameters for spin spinning were established as the following: distance to the collector, 15 cm; relative humidity of the medium, 35%; ambient temperature 21° C.

The fibrous sheets were collected and a powder inoculant of the arbuscular endomicorrhizal fungus Rhizophagus irregularis previously known as Glomus intraradices was attached to its surface. The process was generated until obtaining a fibrous sheet composed of three sheets of superimposed fibers.

Practical Realization 3. Tests of Mycorrhizal Infectivity.

In order to verify the infected capacity of the mycorrhizal propagules attached to the fibrous scaffold, a multilayer coating on red bean seeds (Phaseolus vulgaris L) previously disinfected by immersion in a 10% aqueous solution of sodium hypochlorite for 5 minutes was continued and then three successive washes were performed with distilled water. The treated seeds were sown in plastic pots (½ gallon) at 5 cm deep, which contained a previously sterilized substrate of Canadian Sphagnum peat, perlite and dolomite. A negative control was carried out with the same guidelines and a positive control corresponding to a conventional method of inoculation where the plants received 4 g of the inoculant 2 cm below an uncoated seed.

After 30 days, the treated plants were harvested and the root system was separated from the rest of the plants to detect the presence of mycorrhizal structures in the roots using 0.05% tryptan blue staining in lactoglycerol. To quantify the percentage of root mycorrhization, the quadrant interception method was used, which showed an infectivity percentage of 58.30% for the positive control and 60.0% for the PVP, which showed that the infectivity of the propagules was not affected. to be adhered to the polymer fibers and contain between 85%-75% less fungal inoculum with respect to the conventional inoculation method.

1. A method for producing a biohybrid material composed of microfibers or nanofibers and a fungal propagules that serves as a delivery system for fungi in the agricultural, forestry, and ecological remediation field, the method comprising the steps of:
producing the microfibers or nanofibers from polymers or copolymers;
encapsulating the fungal propagules in fibrous sheets or adhered on the fiber surfaces during or after synthetizing the microfibers or nanofibers.

2. The method according to claim 1, comprising biodegradable and biocompatible polymers with fungal units and plants.

3. The method according to claim 1, wherein the nanofibers or microfibers are selected from the group consisting of cellulose, chitosan, calcium alginate, chitin, collagen, polyvinyl alcohol (PVA), polyethylene oxide (PEO), carboxymethylcellulose (CMC), and polyvinylpyrrolidone (PVP).

4. The method according to claim 1, further including water-soluble polymers or an organic solvent, such as ethanol, chloroform, N, N-dimethylformamide (DMF), or mixture thereof.

5. The method according to claim 1, wherein the nanofibers or microfibers are produced by techniques such as electro-spinning, self-assembly, induced thermal-phase separation, polymerization, sonochemical synthesis, template synthesis, plasma induction, centrifugal spinning, and electrohydrodynamic writing.

6. The method according to claim 1, wherein the fungal propagules are selected from the group consisting of Trichoderma harzianum, Trichoderma viride, Trichoderma asperellum. Rhizophagus irregularis, Glomus aggregatum, and Glomus aggregatum.

7. The method according to claim 1, wherein the fungal propagules are by lyophilization, freezing, or drying.

8. The method according to claim 1, wherein the fungal propagules are contained in formulations such as gels, pills, capsules, or compressed powders.
